(19) United States
(12) Patent Application Publication
(10) Pub. No.: US 2007/0098488 A1
(43) Pub. Date: May 3, 2007

(54) FASTENING STRUCTURE AND METHOD THEREOF

(76) Inventor: Yu-Wei Liu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,094

(22) Filed: Dec. 15, 2005

(30) Foreign Application Priority Data
Oct. 24, 2005 (TW) 094137139

(51) Int. Cl. F16D 1/072

(52) U.S. Cl. 403/274; 29/505

(57) ABSTRACT

A first end of an elongated hole of a first element is coupled with a second element, and then the first element is moved via the elongated hole so that a second end of the elongated hole can be positioned at the second element. Finally, the material protruding through the elongated hole is melted to bond the second element and the first element at the second end of the elongated hole.

### BACKGROUND OF THE INVENTION

1. Field of the Invention

The present invention relates to a fastening method, and more particularly, to a fastening method of coupling a first element having an elongated hole with a second element.

2. Description of the Prior Art

Please refer to FIGS. 1 and 2, which are respectively a top view and a side view of a fastening method according to the prior art. There is a plurality of round holes 11 on a first element 10. The first element 10 is positioned on a second element 14 of a base 13 via the round holes 11. There is some material 12 on the top of the second element 14. When the first element 10 is positioned on the second element 14, the material 12 protrudes through the first element 10, as shown in FIG. 2. Next, the material 12 is melted by application of heat, and the melted material 12 bonds the first element 10 and the second element 14 together. Please refer to FIG. 3, which is a side view showing the melting of the material 12 of FIG. 2. The first element 10 is capable of being fastened on the second element 14 via the melted material 12.

The fastening method of the prior art is quite simple. The prior art requires two steps: vertically positioning the round holes 11 of the first element 10 through the second element 14, and melting the material 12. However, the fastening method of the prior art is not suitable for all assembly work. If the first element 10 is not capable of being vertically positioned on the second element 14, the fastening method mentioned above cannot be performed.

### SUMMARY OF THE INVENTION

The claimed invention discloses a fastening method. The fastening method comprises coupling a first element and a second element, wherein the first element forms an elongated opening, and the second element passes through the elongated opening at a first end of the elongated opening, moving the first element along the elongated opening and maintaining the second element in the elongated hole so that a second end of the elongated hole of the first element is positioned at the second element, and melting an end of the second element to bond the first element at the second end of the elongated hole.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1 and 2 are respectively a top view and a side view of a fastening method according to the prior art.

FIG. 3 is a side view of melting the material of FIG. 2.

FIG. 4 is a top view of an assembly according to the present invention.

FIG. 5 is a top view of the final location of the first element of FIG. 4.

FIG. 6 is a side view of FIG. 5.

FIG. 7 is a side view of melting the stud of FIG. 6.

FIG. 8 is a top view of the initial location of the first element according to the present invention.

FIG. 9 and FIG. 10 are respectively a top view and a side view of the final location of the first element on the base according to the present invention.

FIG. 11 is a side view of melting the stud of FIG. 10.

### DETAILED DESCRIPTION

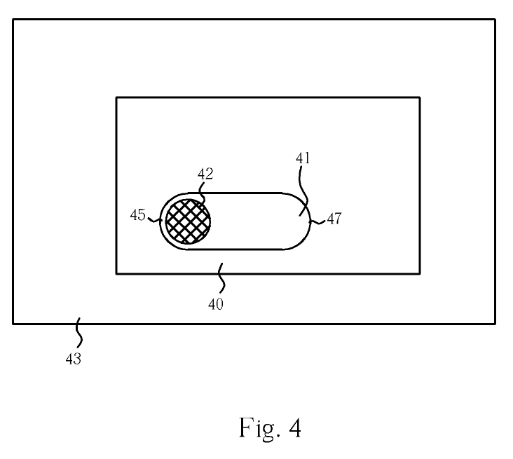

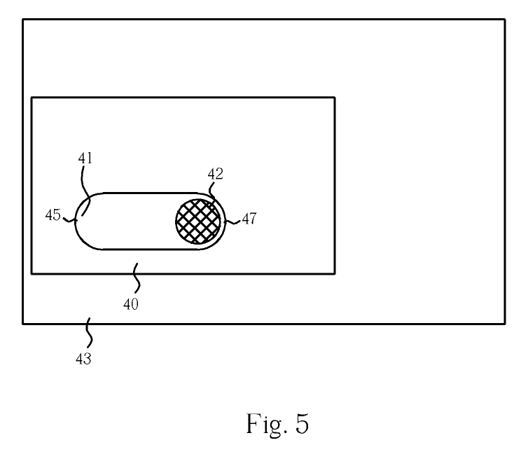

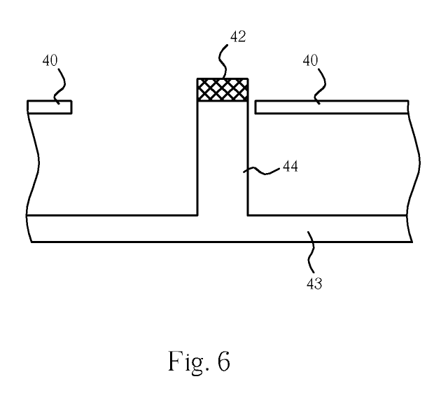

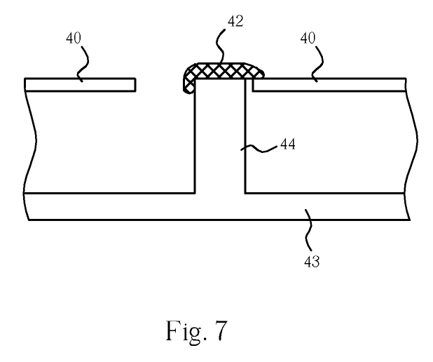

Please refer to FIG. 4, which is a top view of an assembly according to the present invention. A first element 40 comprises an elongated hole 41. A first end 45 of the elongated hole 41 of the first element 40 is positioned at a second element 44 (shown in FIG. 6) of a base 43. There is a stud 42 on the top of the second element 44, and the stud 42 protrudes through the first element 40. Next, the first element 40 is moved while maintaining the second element 40 in the elongated hole 41 so that a second end 47 of the elongated hole 41 of the first element 40 is positioned at the second element 44, as shown in FIG. 5. Finally, the stud 42 is melted by application of heat, and the melted stud 42 bonds the second element 44 and the first element 40 at the second end 47 of the elongated hole 41. Please refer to FIG. 6 and 7. FIG. 6 is a side view of FIG. 5, and FIG. 7 is a side view of melting the stud 42 of FIG. 6. The stud 42 and the second element 44 are monolithically formed and made of hot-melting adhesive material.

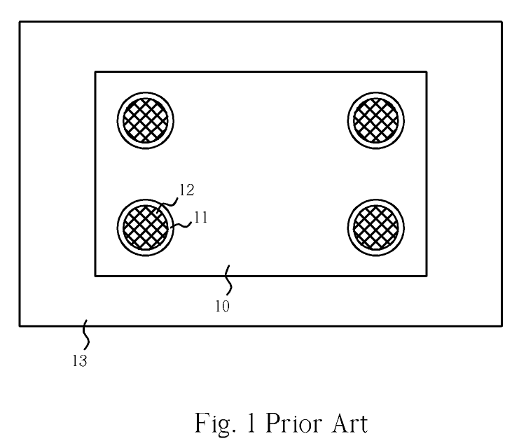

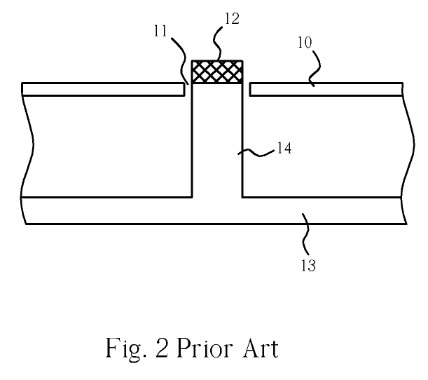

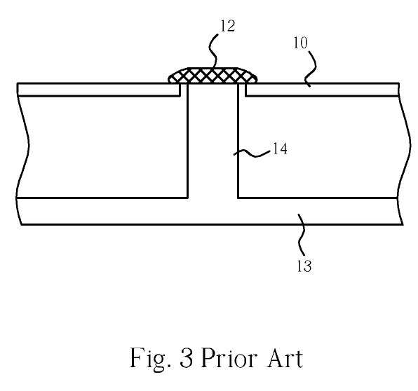

Suppose that the first element 10 is not capable of being vertically positioned at the second element 14 as shown in FIG. 1. With the elongated hole 41, the first element 40 can be moved and positioned at the final location, and then a fastening method can be performed.

Additionally, a part of the melted stud 42 of FIG. 7 is bonded with the first element 40, and a part of the melted stud 42 is not bonded with anything. Suppose that there is a push-button positioned at a side of the first element 40. When pressing the push-button, the entire first element 40 must bear an external force. If the external force is too large, it might break the stud 42 bonded with the first element 40 because an adhesion force between the first element 40 and the second element 44 is weak. Therefore, the present invention provides another embodiment to solve this problem.

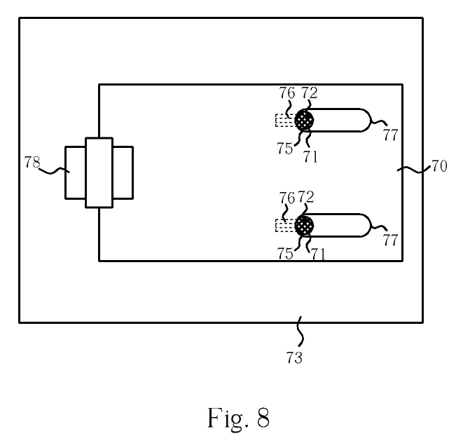

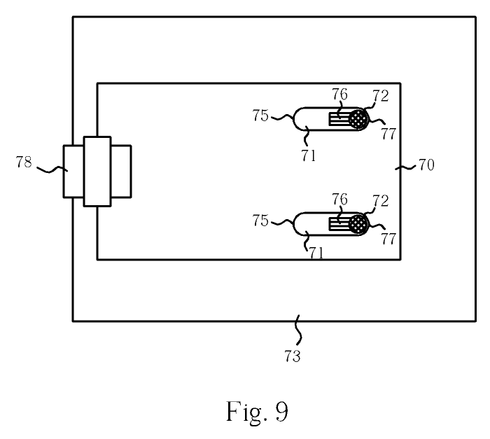

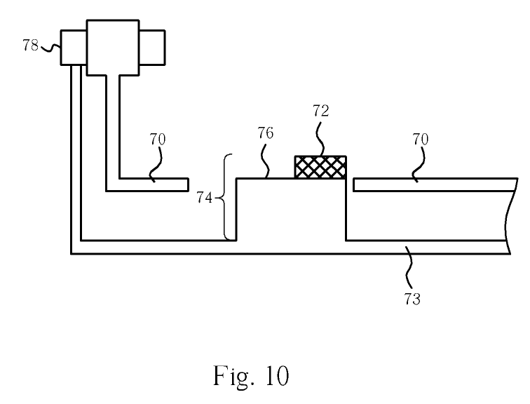

Please refer to FIG. 8 to FIG. 10. FIG. 8 is a top view of the initial location of a first element 70 on a base 73 according to the present invention. FIG. 9 and FIG. 10 are respectively a top view and a side view of the final location of the first element 70 on the base 73. The first element 70 further comprises a push-button 78. First, a first end 75 of an elongated hole 71 of the first element 70 is positioned at a second element 74, as shown in FIG. 8. Next, the first element 70 is moved to the final location via the elongated hole 71. That is, the first end 75 of the elongated hole 71 is moved from the second element 74, and a second end 77 of the elongated hole 71 is positioned at the second element 74, as shown in FIG. 9. In FIG. 10, the structure of the second element 74 is shown. In addition to a stud 72, the second element 74 further comprises a supporting base 76 for supporting the melted stud 72. The second element 74, the stud 72 and the supporting base 76 are monolithically formed and made of hot-melting adhesive material.

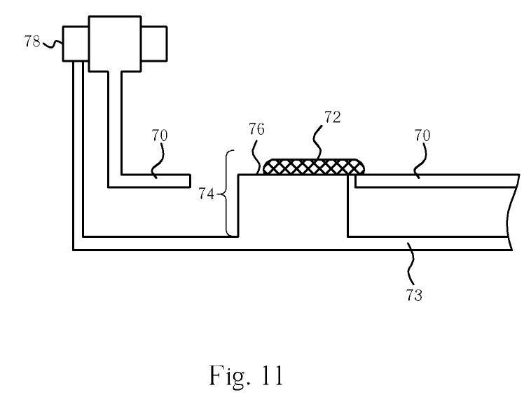

Please refer to FIG. 11, which is a side view of melting the stud 72 of FIG. 10. A part of the melted stud 72 is bonded with the first element 70, and a part of the melted stud 72 is bonded with the supporting base 76. In this way, the adhesion force between the first element 70 and the second element 74 is increased, resolving the problem that a part of the melted stud 42 is not bonded with any first element in FIG. 7.

The present invention provides a fastening method to reduce complexity of assembly. The present invention changes the round hole into the elongated hole so as to allow easy movement of the first element. Additionally, there is a supporting base on the second element to support melted material, thereby increasing the adhesion force between the first element and the second element.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fastening method comprising:
coupling a first element and a second element, wherein the first element forms an elongated opening, and the second element passes through the elongated opening at a first end of the elongated opening;
moving the first element along the elongated opening and maintaining the second element in the elongated hole so that a second end of the elongated hole of the first element is positioned at the second element; and
melting an end of the second element to bond the first element at the second end of the elongated hole.

2. The fastening method of claim 1, wherein melting the end of the second element comprises melting a part of the second element protruding from the elongated hole.

3. The fastening method of claim 1, wherein coupling the first end of the elongated hole of the first element with the second element comprises piercing a stud of the second element through the elongated opening at the first end of the elongated opening of the first element.

4. A fastening structure comprising:
a first element having an elongated hole; and
a second element comprising a stud and a supporting base, the stud disposed on the supporting base and protruding through the elongated hole of the first element.

5. The fastening structure of claim 4, wherein the stud and the supporting base are monolithically formed.

6. A fastening structure comprising:
a first element having an elongated hole, the stud of the second element; and
a second element comprising a stud and a supporting base, the stud disposed on the supporting base and protruding through the elongated hole of the first element, the supporting base for supporting a melted part of the stud.

7. The fastening structure of claim 6, wherein the stud and the supporting base are monolithically formed.
